(19) United States
(12) Patent Application Publication
(10) Pub. No.: US 2016/0104077 A1
(43) Pub. Date: Apr. 14, 2016

(54) System and Method for Extracting Table Data from Text Documents Using Machine Learning

(71) Applicant: The Trustees of Columbia University in the City of New York, New York, NY (US)

(72) Inventors: Robert J. Jackson, JR., New York, NY (US); Joshua R. Mitts, Jersey City, NJ (US); Jing Zhang, New York, NY (US)

(73) Assignee: The Trustees of Columbia University in the City of New York, New York, NY (US)

(21) Appl. No.: 14/879,349

(22) Filed: Oct. 9, 2015

Related U.S. Application Data
(60) Provisional application No. 62/062,259, filed on Oct. 10, 2014.

(51) Int. Cl. G06N 99/00; G06F 17/30

(52) U.S. Cl. CPC G06N 99/005; G06F 17/30011

(57) ABSTRACT

Systems and methods for extracting table data from text documents using machine learning are provided. The systems and methods comprise electronically receiving at a computer system a document having one or more tables, each table having one or more whitespace features, processing the document using a first computer model executed by the computer system to classify each row of the one or more tables as a header row or a data row, processing the document using a second computer model executed by the computer system to classify each whitespace feature in each row conditional on classification of each row by the first computer model, the second computer model identifying whether a whitespace feature corresponds to information missing from the one or more tables, and generating an output of the classified whitespace features and storing the output in a digital file.

### CROSS-REFERENCE TO RELATED APPLICATIONS

This application claims the benefit of U.S. Provisional Application Ser. No. 62/062,259 filed on Oct. 10, 2014, the entire disclosure of which is expressly incorporated herein by reference.

### BACKGROUND

The present disclosure relates to a system and method for extracting data from documents. More specifically, the present disclosure relates to a system and method for extracting table data from text documents using machine learning.

Computer systems are increasingly relied on to extract text and other information from documents. Text-only digital documents (e.g., financial filings) often contain important data formatted as tables, where the content of such tables of data is valuable and important for a wide range of data analysis purposes and applications. While text tables are a helpful way for humans to read and understand data, computers often have difficulty properly extracting text table data.

Some existing table extraction algorithms employ various heuristics that rely on simple assumptions about tabular structure (e.g., they assume simple table cell format, they find header cells that intersect horizontally and vertically, etc.). However, tabular structure in text-only documents is not standardized, thereby resulting in numerous possible variations in table structure and format. Accordingly, heuristic algorithms may not lead to robust solutions (e.g., they may perform poorly and/or fail) when confronted with documents that have text tables that deviate from simplistic assumptions and/or have unusual formats (e.g., contain column headers that spans multiple columns of data, data that span multiple columns, cells which may be empty in their entirety, etc.). Further, some computer systems apply statistical machine learning (e.g., conditional random field classifiers) to identify, classify, and extract table rows from documents, which is useful but insufficient for answer retrieval. These limitations severely restrict the value of such algorithms to data extraction applications.

### SUMMARY

Systems and methods for extracting table data from text documents using machine learning are provided. The systems and methods comprise electronically receiving at a computer system a document having one or more tables, each table having one or more whitespace features, processing the document using a first computer model executed by the computer system to classify each row of the one or more tables as a header row or a data row, processing the document using a second computer model executed by the computer system to classify each whitespace feature in each row conditional on classification of each row by the first computer model, the second computer model identifying whether a whitespace feature corresponds to information missing from the one or more tables, and generating an output of the classified whitespace features and storing the output in a digital file.

### BRIEF DESCRIPTION OF THE DRAWINGS

The foregoing features of the present disclosure will be apparent from the following Detailed Description, taken in connection with the following drawings, in which:

FIG. 1 is a diagram showing process steps for creating and training a text table extraction engine using machine learning;

FIG. 2 is a flowchart showing processing steps for training a random fields classifier;

FIG. 3 is a flowchart showing processing steps taken by the text table extraction engine to extract data from text tables and generate an output;

FIG. 4 is a diagram showing inputs, outputs, and components of the text table extraction engine; and

FIG. 5 is a diagram showing sample hardware components for implementing the system.

### DETAILED DESCRIPTION

The present disclosure relates to a system and method for text table extraction. The system applies a non-heuristic, predictive machine learning algorithm to automatically extract data tables (e.g., rows and cells of tables) from documents (e.g., text-only digital documents). The tables could be formatted using ASCII text, such that rows are delineated with newlines and separator characters (e.g., “—”) and columns are delineated with spaces and/or separator characters (e.g., “|”).

The text table extraction engine employs a machine learning classification module (e.g., engine, module, algorithm, etc.) to automatically extract the cells of a text table in a non-heuristic manner (e.g., in a manner that is robust to extensive variation in the positioning of column headers and data cells). The text table extraction engine is robust to wide variations in data, particularly for text tables with complex structures or formats (e.g., with column headers that span multiple columns of data, data that span multiple columns, cells which may be empty in their entirety, etc.). The text table extraction engine provides highly accurate extraction of data from tables within a text-only document.

The text table extraction engine could provide automated extraction of important data (e.g., financial, medical, news data) embedded in textual documents, such as for text mining for big data analytics. More specifically, the text table extraction engine could extract financial data in textual tables in Securities and Exchange Commission filings, which could be of importance to members of the financial services industry and other sectors. The ability to automatically extract such data (which are typically extracted by hand and then provided to financial-services consumers) with exceptional speed and accuracy could result in a reduction in costs and delays associated with manual table data extraction. Accordingly, the present disclosure provides an improvement in the quality and speed of computer text table extraction. The present disclosure provides the elements necessary for a computer to effectively extract text table information.

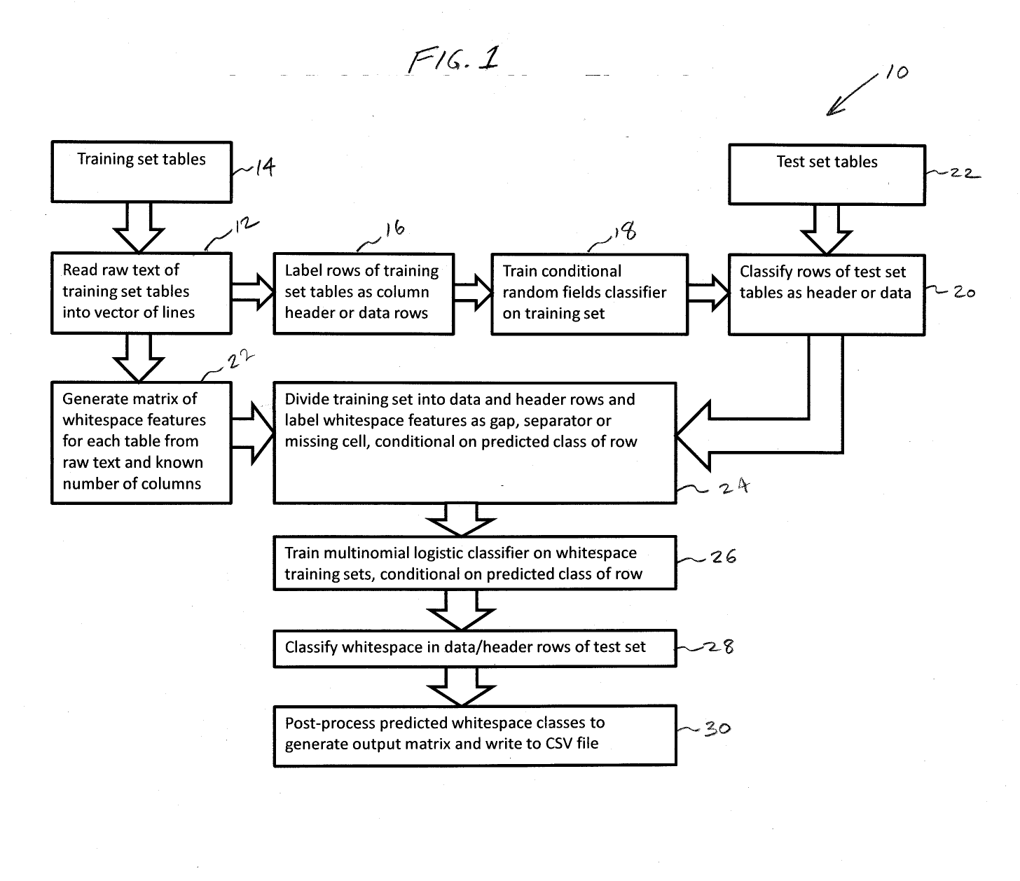

FIG. 1 is a diagram showing a process 10 for creating and training a text table extraction engine/module using machine learning techniques. At 12-20 (described in more detail below), the text table extraction engine classifies table rows (e.g., column header, data row, etc.). At 22-28 (described in more detail below), the text table extraction engine classifies columns and/or cells (e.g., gap, separator, missing cell, etc.). The text table extraction engine/module of the present disclosure is a specially-programmed software component which, when executed by a computer system, causes the computer system to perform the various functions and features described herein. It could be programmed in any suitable high- or low-level programming language, such as Java, C, C++, C#, .NET, etc.

At 12, the text table extraction engine electronically reads raw text of training sets of tables 14 and converts the raw text into character vectors of lines (strings). More specifically, the text table extraction engine reads one or more tables from the training set of tables 14 into a vector of characters in memory (e.g., string of memory). The text table extraction engine receives the training set of tables 14 as input to train the engine.

At 16, the text table extraction engine labels rows of the training set tables as column headers or data rows. More specifically, rows of training set tables are labeled as column headers, data rows, separator rows, etc. An example of such labeling is as follows:

TABLE 1

| | | | | | | Label |
|---|---|---|---|---|---|---|
| | | | | LONG-TERM | | Header |
| | | ANNUAL | | COMPENSATION | | Header |
| | | COMPENSATION | | AWARDS | | Header |
| | | ----------------- | | ------------ | | Separator |
| | | | | SECURITIES | | Header |
| NAME AND PRINCIPAL | | | | UNDERLYING | ALL OTHER | Header |
| POSITION | YEAR | SALARY | BONUS (1) | OPTIONS (#) | COMPENSATION (2) | Header |
| ------------------ | ---- | -------- | -------- | ------------ | --------------- | Separator |
| <S> | <C> | <C> | <C> | <C> | <C> | S/C |
| William H. Gates . . . | 1996 | $340,618 | $221,970 | 0 | $0 | Record |
| Chairman of the Board; | | | | | | Subrecord |
| Chief | 1995 | 275,000 | 140,580 | 0 | 0 | Record |
| Executive Officer; | | | | | | Subrecord |
| Director | 1994 | 275,000 | 182,545 | 0 | 0 | Record |
| Steven A. Ballmer . . . | 1996 | 271,869 | 212,905 | 0 | 4,875 | Record |
| Executive Vice | | | | | | Subrecord |
| President, | 1995 | 249,174 | 162,800 | 0 | 4,770 | Record |
| Sales and Support | 1994 | 238,750 | 188,112 | 0 | 4,722 | Record |
| Robert J. Herbold . . . | 1996 | 471,672 | 608,245 | 0 | 12,633 | Record |
| Executive Vice | | | | | | Subrecord |
| President; Chief | 1995 | 286,442 | 453,691 | 325,000 | 99,241 | Record |
| Operating Officer | | | | | | Subrecord |
| Paul A, Maritz . . . | 1996 | 244,382 | 222,300 | 24,000 | 5,175 | Record |
| Group Vice President, | | | | | | Subrecord |
| Platforms | 1995 | 203,750 | 138,794 | 150,000 | 4,722 | Record |
| | 1994 | 188,750 | 160,278 | 50,000 | 4,722 | Record |
| Bernard P. Vergnes . . . | 1996 | 398,001 | 226,191 | 0 | 0 | Record |
| Senior Vice President, | | | | | | Subrecord |
| Microsoft; | 1995 | 356,660 | 169,785 | 150,000 | 0 | Record |
| President of Microsoft | | | | | | Subrecord |
| Europe | 1994 | 300,481 | 196,885 | 40,000 | 0 | Record |

As shown above, the “record” vs. “subrecord” distinction permits distinguishing between rows with actual data and those that simply continue the prior record.

At 18, the text table extraction engine trains a conditional random fields classifier using the training set of tables 14. Then, at 20, the text table extraction engine classifies rows of a test set of tables 22 (e.g., column header, data rows, etc.). The text table extraction engine receives the test set of tables 22 as input (e.g., to further train the engine). A conditional random fields classifier is a class of statistical modelling (e.g., applied in machine learning) for structured prediction, which can take context into account. Conditional random fields classifier is a type of discriminative undirected probabilistic graphical model.

At 22, the text table extraction engine generates a matrix of whitespace features for each table from raw text (e.g., of step 12) and/or a known number of columns. The matrix of whitespace features could include the length of the whitespace, the total number of whitespaces in the row, the distance between the whitespace and the closest non-whitespace content in an adjacent row on either the left or right sides (as well as the maximum of the two), the number of alphanumeric characters, and/or whether the whitespace is exceptionally long compared to other whitespaces in the line, etc.

At 24, the text table extraction engine divides the training set into data and header rows, and labels whitespace features. The text table extraction engine uses the generated matrix of whitespace features to label white space features, where the label applied by the text table extraction engine is conditional on the predicted class of row (e.g., from step 20). The text table extraction engine could classify whitespace features (e.g., a space, tab, etc.) as a gap, column, separating words within a cell (e.g., separator), missing cell in the matrix layout of the table, etc. In this way, the matrix of whitespace features are predictive of whether the whitespace character is a column separator, within-cell gap, etc.

At 26, after the whitespaces are labeled, the text table extraction engine trains a multinomial logistic classifier (e.g., probabilistic classifier) on whitespace training sets (e.g., labeled set of training data) conditional on the predicted class (e.g., type) of the row to predict the classes of unlabeled whitespaces, as discussed in more detail below. The text table extraction engine correctly identifies and maps column headers to the columns of the table (e.g., column table headers are mapped to the column(s) that they span), the number of which could be known in the dataset. In other words, the text table extraction engine takes into account whether a column header spans more than one column, and properly maps such headers to the underlying columns that they span.

At 28, the text table extraction engine classifies whitespace in the rows (e.g., data rows, header rows, etc.) of the test set. More specifically, the text table extraction engine automatically selects a random sample of tables to generate a training set. Each of the whitespaces in each line of the table are labeled with their class (e.g., a gap, separator or missing cell) conditional on the predicted class of the row (e.g., header, data, etc.). Then, at 30, the text table extraction engine post-processes the predicted whitespace classes to generate an output matrix and/or writes the generated output matrix to a file (e.g., CSV file).

The text table extraction engine could be combined with one or more other text extraction engines capable of rendering graphical tables in text-only format, which could improve data extraction from digital formats (e.g., PDF). The text table extraction engine could be adapted to handle nested tables and improve table extraction from semi-structured documents (e.g., HTML, XML, etc.). Further, the text table extraction engine could be combined with optical character recognition (OCR) software to effectively digitize tabular data on physical media.

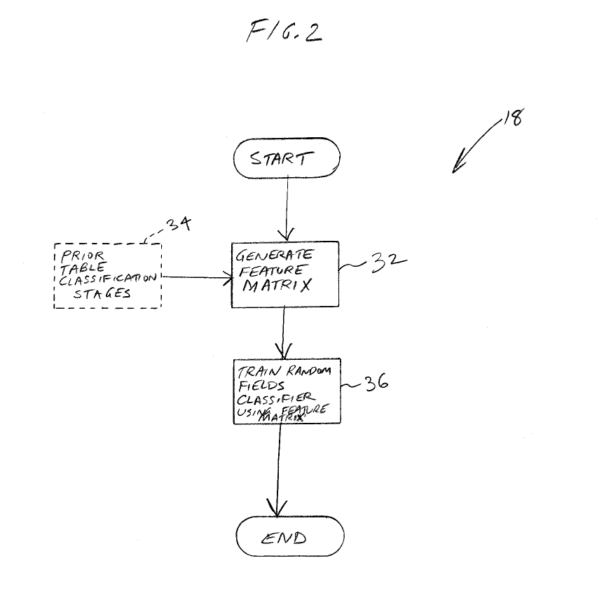

FIG. 2 is a flowchart showing a process 18 for training a random fields classifier (e.g., table row classifier). At 32, the text table extraction engine generates a feature matrix corresponding to the distinguishing features between header and data rows, as well as distinguishing features of different types of data rows. The row classification feature matrix could include one or more types of features, such as number of consecutive spaces and/or indents, single space indent, number of gaps, length of a large gap, blank-line all space, percentage of white space, separator, four consecutive periods, percentage of the non-white space characters on the line, and/or percentage of the non-white space digits on the line, etc. These features avoid reliance on heuristic assumptions, enable robust extraction of data over a wide range of variations in the format of text tables, and provides for text table cell extraction with a high degree of accuracy.

The feature matrix (e.g., distinguishing features) could be conditional on a prior table classification stage shown at 34, although this is not necessary if the tables are sufficiently similar. Once a feature matrix has been generated, at 36 a conditional random fields classifier is trained on the training set and applied to unlabeled rows to classify as header, date, separator, etc.

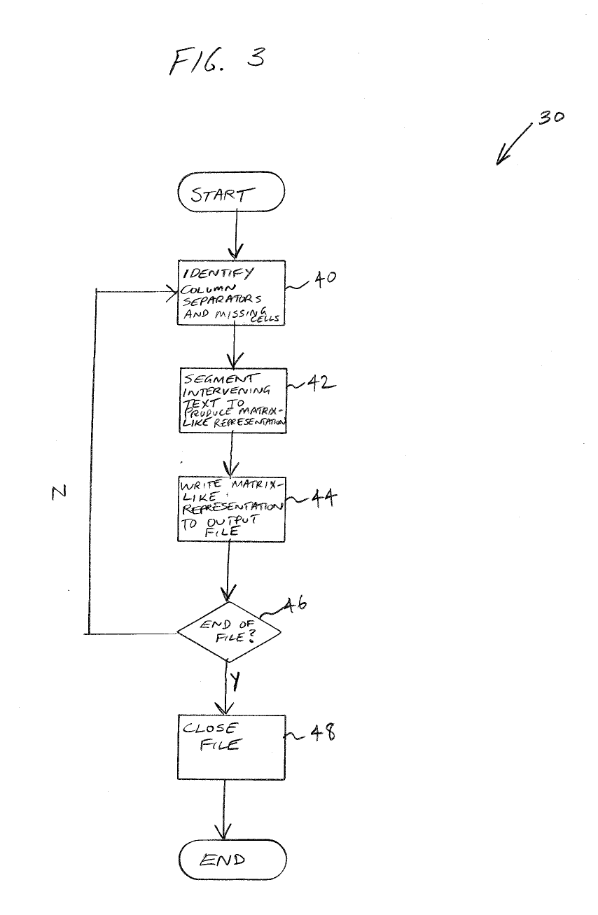

FIG. 3 is a flowchart showing a process 30 carried out by the text table extraction engine to extract data from text tables and generate an output. More specifically, at 40, the text table extraction engine processes the classified white spaces to identify column separators, missing cells, etc. At 42, the text table extraction engine segments the intervening text to produce a matrix-like representation of the textual table. At 44, the text table extraction engine writes the matrix-like representation to an output computer file, such as in a structured file format (e.g., a CSV file). At 46, the text table extraction engine automatically determines whether the end of the file has been reached. If not, the process returns to 40 and repeats, with the corresponding conditional classification, for the remaining text tables (e.g., column headers and/or data rows). Otherwise, the process proceeds to 48 and the text table extraction engine closes the file.

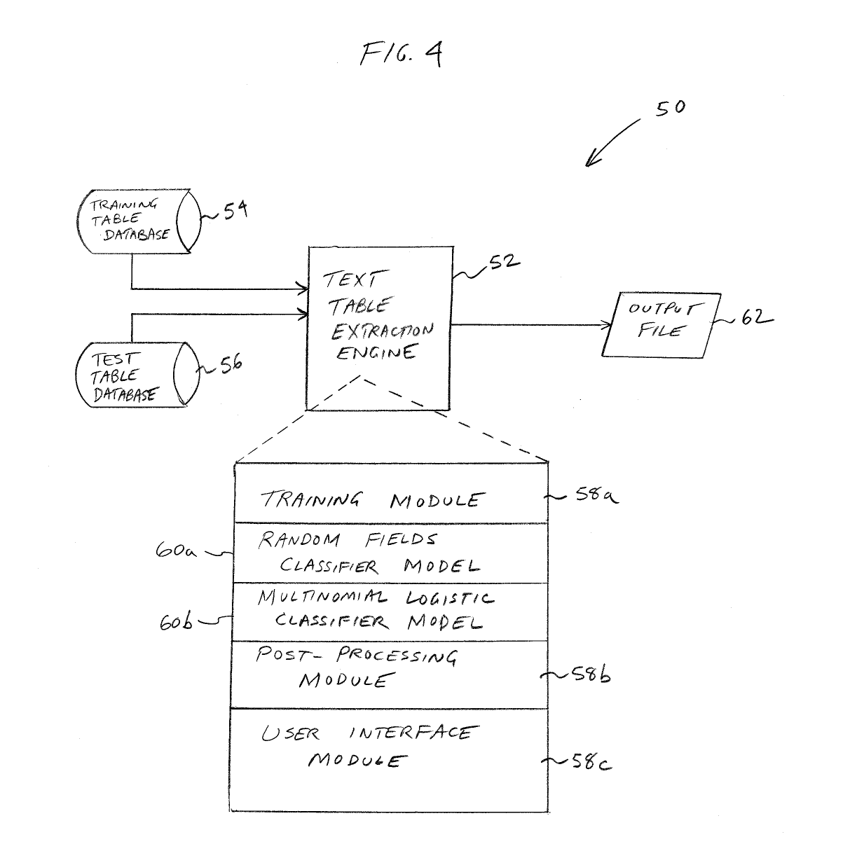

FIG. 4 is a system diagram 50 showing inputs, outputs, and components of the text table extraction engine 52. More specifically, the text table extraction engine 52 electronically receives one or more sets of training tables from a training table database 54 and one or more sets of test tables from a test table database 56. These sets of training tables and test tables are used by the text table extraction engine 52, as discussed above.

The text table extraction engine 52 includes a training module 58a, a post-processing module 58b, a user interface module 58c, a random fields classifier model 60a, and/or a multinomial logistic classifier model 60b. The training module 58a utilizes the training table sets and the test table sets to train the text table extraction engine 52. The conditional random fields classifier model 60a classifies rows of a table, and then the multinomial logistic classifier model 60b is subsequently applied to predict and classify whitespace found in the header and/or data row of a table to delineate a column separator, empty cell, gap (e.g., separating two words within a table cell), etc. The post-processing module 58b then generates one or more output files 62, as discussed above. More specifically, the post-processing module 58b produces a matrix-like data structure of the rows and columns of a text table. The user interface module 58c displays the output to a user through a user interface generated by the user interface module 58c. The process performed by the modules 581-58c and models 60a-60b are discussed above in connection with FIGS. 1-3.

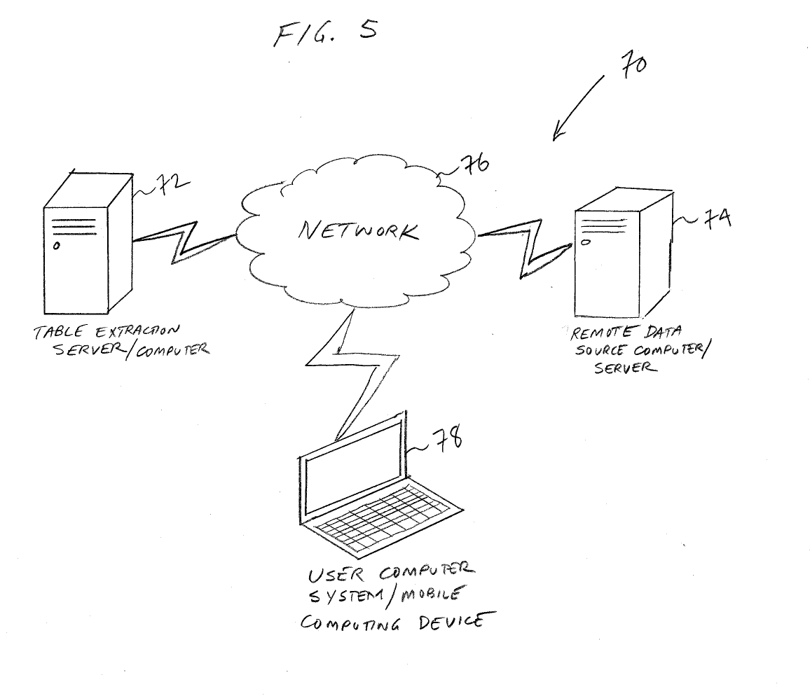

FIG. 5 is a diagram 70 showing sample hardware components for implementing the present disclosure. A table extraction server/computer 72 could be provided, and could include a database (stored on the computer system or located externally therefrom) and the table text extraction engine stored therein and executed by the table extraction server/computer 72. The table extraction server/computer 72 could be in electronic communication over a network 76 with a remote data source computer/server 74, which could have a database (stored on the computer system or located externally therefrom) digitally storing sets of training tables, sets of testing tables, etc. The remote data source computer/server 74 could comprise one or more government entities, such as those storing Securities and Exchange Commission (SEC) records and filings. Of course, other types of text table data could be provided without departing from the spirit or scope of the present disclosure.

Both the table extraction server/computer 72 and the remote data source computer/server 74 could be in electronic communication with one or more user computer systems/mobile computing devices 78. The computer systems could be any suitable computer servers (e.g., a server with a microprocessor, multiple processors, multiple processing cores) running any suitable operating system (e.g., Windows by Microsoft, Linux, UNIX, etc.). Network communication could be over the Internet using standard TCP/IP and/or UDP communications protocols (e.g., hypertext transfer protocol (HTTP), secure HTTP (HTTPS), file transfer protocol (FTP), electronic data interchange (EDI), dedicated protocol, etc.), through a private network connection (e.g., wide-area network (WAN) connection, emails, electronic data interchange (EDI) messages, extensible markup language (XML) messages, file transfer protocol (FTP) file transfers, etc.), or using any other suitable wired or wireless electronic communications format. Also, the systems could be hosted by one or more cloud computing platforms, if desired. Moreover, one or more mobile computing devices (e.g., smart cellular phones, tablet computers, etc.) could be provided.

Having thus described the system in detail, it is to be understood that the foregoing description is not intended to limit the spirit or scope thereof. It will be understood that the embodiments described herein are merely exemplary and that a person skilled in the art may make many variations and modification without departing from the spirit and scope of the present disclosure. All such variations and modifications, including those discussed above, are intended to be included within the scope of the present disclosure.

What is claimed is:

1. A method for electronically extracting table data from text documents using machine learning, comprising:
electronically receiving at a computer system a document having one or more tables, each table having one or more whitespace features;
processing the document using a first computer model executed by the computer system to classify each row of the one or more tables as a header row or a data row;
processing the document using a second computer model executed by the computer system to classify each whitespace feature in each row conditional on classification of each row by the first computer model, the second computer model identifying whether a whitespace feature corresponds to information missing from the one or more tables; and
generating an output of the classified whitespace features and storing the output in a digital file.

2. The method of claim 1, wherein the first computer model comprises a random fields classifier.

3. The method of claim 2, wherein the random fields classifier is trained using a set of training tables.

4. The method of claim 1, wherein the second computer model comprises a multinomial logistic classifier.

5. The method of claim 4, wherein the multinomial logistic classifier is trained using a set of training tables.

6. The method of claim 1, wherein the information missing comprises a missing cell.

7. A non-transitory computer-readable medium having computer-readable instructions stored thereon which, when executed by a computer system, cause the computer system to perform the steps of:
electronically receiving at a computer system a document having one or more tables, each table having one or more whitespace features;
processing the document using a first computer model executed by the computer system to classify each row of the one or more tables as a header row or a data row;
processing the document using a second computer model executed by the computer system to classify each whitespace feature in each row conditional on classification of each row by the first computer model, the second computer model identifying whether a whitespace feature corresponds to information missing from the one or more tables; and
generating an output of the classified whitespace features and storing the output in a digital file.

8. The non-transitory computer-readable medium of claim 7, wherein the first computer model comprises a random fields classifier.

9. The non-transitory computer-readable medium of claim 8, wherein the random fields classifier is trained using a set of training tables.

10. The non-transitory computer-readable medium of claim 7, wherein the second computer model comprises a multinomial logistic classifier.

11. The non-transitory computer-readable medium of claim 10, wherein the multinomial logistic classifier is trained using a set of training tables.

12. The non-transitory computer-readable medium of claim 7, wherein the information missing comprises a missing cell.

13. A system for electronically extracting table data from text documents using machine learning, comprising:
a computer system for electronically receiving a document having one or more tables, each table having one or more whitespace features;
an engine executed by the computer system, the engine:
processing the document using a first computer model executed by the computer system to classify each row of the one or more tables as a header row or a data row;
processing the document using a second computer model executed by the computer system to classify each whitespace feature in each row conditional on classification of each row by the first computer model, the second computer model identifying whether a whitespace feature corresponds to information missing from the one or more tables; and
generating an output of the classified whitespace features and storing the output in a digital file.

14. The system of claim 13, wherein the first computer model comprises a random fields classifier.

15. The system of claim 14, wherein the random fields classifier is trained using a set of training tables.

16. The system of claim 13, wherein the second computer model comprises a multinomial logistic classifier.

17. The system of claim 16, wherein the multinomial logistic classifier is trained using a set of training tables.

18. The system of claim 13, wherein the information missing comprises a missing cell.
